(19) United States
(12) Patent Application Publication
(10) Pub. No.: US 2019/0301622 A1
(43) Pub. Date: Oct. 3, 2019

(54) CHECK VALVE FOR SLURRY WATER PUMP

(71) Applicant: Federal Signal Corporation, Oak Brook, IL (US)

(72) Inventor: Xiaolun Huang, Naperville, IL (US)

(21) Appl. No.: 16/372,980

(22) Filed: Apr. 2, 2019

Related U.S. Application Data
(60) Provisional application No. 62/652,045, filed on Apr. 3, 2018.

(51) Int. Cl. F16K 15/02; F16K 1/46

(52) U.S. Cl. CPC F16K 15/028; F16K 1/12; F16K 1/46

(57) ABSTRACT

An improved check valve includes a valve seat having a seating surface and a guiding barrel body; the seating surface having a groove; an elastomeric seal member oriented in the groove; a valve cage having a cylindrical valve cage body and opposite open and closed ends, the closed end being closed by a valve disk; the valve cage body having a plurality of windows allowing fluid flow therethrough; the valve cage body being sized to slide inside of the guiding barrel body; the valve cage further including a groove at an outer perimeter adjacent the open end of said valve cage body; a retainer arrangement including a washer and a lock ring; the washer having a recess pocket and being sized to slide over the valve cage and against the guiding barrel body; the lock ring being seated within the groove of the valve cage and having an outer diameter sized to be oriented within the recess pocket of the washer; and a compression spring oriented outside of the guiding barrel body and held by the retainer arrangement between the open end of the valve cage and against the valve seat to urge the seating surface of the valve seat against the valve disk.

### CROSS REFERENCE TO RELATED APPLICATIONS

This application claims priority to U.S. Provisional Patent Application Ser. No. 62/652,045, filed Apr. 3, 2018 the disclosure of which is incorporated herein by reference in its entirety.

### TECHNICAL FIELD

The present disclosure generally relates to an improved check valve and, more particularly, to a valve used in high power reciprocating water pumps such as in sewer cleaning and hydra-excavation utility vehicles.

### BACKGROUND

Reciprocating displacement pumps have been developed long time ago and broadly used in many industries. For mobile utility vehicles, such as sewer trucks and hydra-excavation trucks, most of those reciprocating water pumps are of pistons (double acting) or plunger (single acting) types.

In a water recycling pump, water is generally in a slurry with contamination of various sizes (in the range up to 150 microns) of particles. It is possible that some solid debris is trapped between the seats and causes poor sealing, which in turn would lead to jetting and wear on the seat surface and damage adjacent components.

There are some valves available in market today for slurry water applications. In many systems, the valve seat is at least partially resilient, such that it would encapsulate and seal around small solid particles trapped between the mating surfaces of the valve and seat. The inserted elastomeric seat member could be mounted either on the seat of the moving valve head or stationary seat body, and typical designs can be found in U.S. Pat. No. 2,329,576 by Anderson and U.S. Pat. No. 2,969,951 by Walton, respectively. Many prior designs have elastomeric members that are specially modeled and practically hard to install or remove for service. In addition, typical resilient seat valves have several disadvantages, including larger requirements for the valve and seat because the space needed for inserting the elastomeric members and for higher impact load at valve closing.

FIG. 1 illustrates impact load on a resilient seat valve in the prior art. In FIG. 1, only the seal on the valve is shown, but the situation is the same for a seal inserted on a valve seat body. The inserted elastomeric member seat will always introduce a gap, the standoff ‘h’, between the seating surfaces. The standoff is necessary to insure that the elastomeric member can seal around any solid particles in the fluid that are trapped between the seating surfaces. One might hope the insert would absorb some valve impact load. However, at high fluid pressure (over 500 psi), an elastomeric material would just behave like a fluid and lost its strength on shape. Thus, the standoff will actually increase impact load: the bigger the travel, the high impact load.

Such an impact load affects life of the valve on some reciprocating pumps. In the application of water pump hydraulically driven by tandem pistons, such as shown in U.S. Pat. No. 3,700,360, the check valves open and close abruptly, caused by nearly instant shifting of the directional valve on pressured fluid. As a result, dynamic loading on these valves is higher than those in a crank-shaft driven pumps where the volumetric change is gradual, typically in a sine function.

Another common drawback of the resilient seat valves in market is that the elastomeric inserts are difficult to replace or service. In addition, the valve seats in these resilient valves are generally larger than a standard one due to adding the insert, which in turn leads to higher bias forces on closing and higher cracking forces to open.

Therefore, it is desirable that an improved valve is structurally strong, tough on impact and wear and tolerant on fluid contamination. In the meantime, it is desirable that such a valve have less dynamic impact on the valve seat during operation. Furthermore, it is desirable that the valve is low cost and easy to service.

### SUMMARY

An improved check valve for use in a slurry fluid pump is provided which improves the prior art.

In one aspect, the improved check valve includes a valve seat having a seating surface and a guiding barrel body; the seating surface having a groove; an elastomeric seal member oriented in the groove; a valve cage having a cylindrical valve cage body and opposite open and closed ends, the closed end being closed by a valve disk; the valve cage body having a plurality of windows allowing fluid flow therethrough; the valve cage body being sized to slide inside of the guiding barrel body; the valve cage further including a groove at an outer perimeter adjacent the open end of said valve cage body; a retainer arrangement including a washer and a lock ring; the washer having a recess pocket and being sized to slide over the valve cage and against the guiding barrel body; the lock ring being seated within the groove of the valve cage and having an outer diameter sized to be oriented within the recess pocket of the washer; and a compression spring oriented outside of the guiding barrel body and held by the retainer arrangement between the open end of the valve cage and against the valve seat to urge the seating surface of the valve seat against the valve disk.

In example embodiments, the seal member is an o-ring.

In some embodiments, the o-ring is oriented at an outer perimeter of the seating surface.

In many example embodiments, the seating surface is spherical.

A variety of examples of desirable product features or methods are set forth in part in the description that follows, and in part, will be apparent from the description, or may be learned by practicing various aspects of the disclosure. The aspects of the disclosure may relate to individual features, as well as combinations of features. It is to be understood that both the foregoing general description, and the following detailed description, are explanatory only, and are not restrictive of the claimed inventions.

### BRIEF DESCRIPTION OF THE DRAWINGS

FIG. 1 is a schematic cross-sectional view showing the impact load caused by an insert standoff.

FIG. 2 is perspective, partially sectional view of an example embodiment of an improved valve, made in accordance with principles of this disclosure.

FIG. 3 is an exploded cross-sectional view of the improved valve of FIG. 2.

FIG. 4 is a schematic cross-sectional view of how an o-ring seal works in the valve of FIGS. 2 and 3.

### DETAILED DESCRIPTION

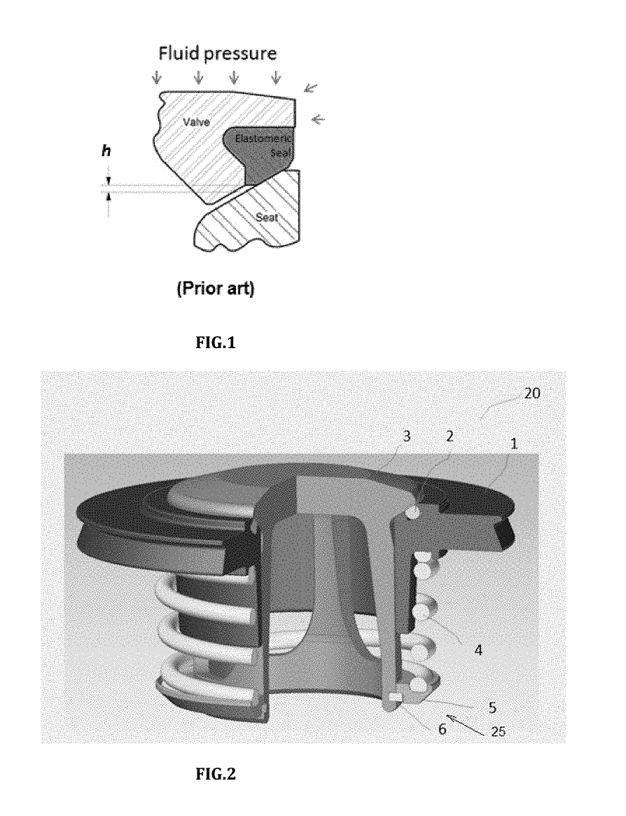

Attention is directed to FIG. 2. An improved check valve is shown generally at 20. The valve 20 includes a valve seat 1, elastomeric seal member (preferably o-ring) 2, valve cage 3, compression spring 4, retainer arrangement 25 including a spring retainer washer 5 and lock ring 6.

In more detail shown in FIG. 4, the valve seat 1 preferably has a spherical seat face or seating surface 10 to mate with a valve disk 7. Also at seating surface 10, preferably at the outer perimeter of face 10 in the illustrated embodiment, there a groove 11 for housing seal member 2, shown as o-ring seal member 2.

The valve seat 1 further includes a guiding barrel body 27, typically cylindrical in shape. The guiding barrel body 27 has an inner diameter 13 is used to guide and support the valve cage 3; an outer diameter 14 generally tapper profile, to guard compression spring 4, and an open end 15 as a mechanical stop to spring retainer washer 5. The guiding barrel body 27 provides an improved guide surface (longer) for better alignment and wear resistance.

The valve seat 1 further includes a shoulder 12 for ease of installation alignment on a mounting block (not shown), as well as a recess to retain one end of the compression spring 4.

The o-ring seal member 2 preferably sticks out of the seating surface 10 at its free-form (uncompressed), in a range between 100 to 700 microns. When the valve disk 7 is closing toward seat 10, the o-ring seal member 2 will be in touch and compressed first momently before the metal-to-metal contact happens. Then, under fluid pressure, it will be reshaped to fill the space confined by the valve seating surface 7 and groove 11 such that a further non-metal sealing is developed. See FIG. 4 for more explanation.

In FIG. 4, on the seating surface 10 of the valve seat 1, there is an o-ring 2. The o-ring 2 is adjacent to outer edge of the seat 1 and occupies a small portion of the seat surface 10; otherwise the valve is the same as a normal metal-to-metal seat valve. In a close phase, the valve moves close to the valve seat 1, and eventually the two seating surfaces will form a closed channel on the o-ring 30. For clean fluid, the contact will be metal-to-metal; for contaminated fluid, there might be solid particles trapped between the seats, resulting a gap. For the later situation, the o-ring 2 will deform and seal the gap like typical stationary seal under high fluid pressure. Experiments show that the o-ring 2 works well on pump fluid contaminated with small solid particles with much longer service life, while having no noticeable difference on dynamic impact comparing to a standard valve.

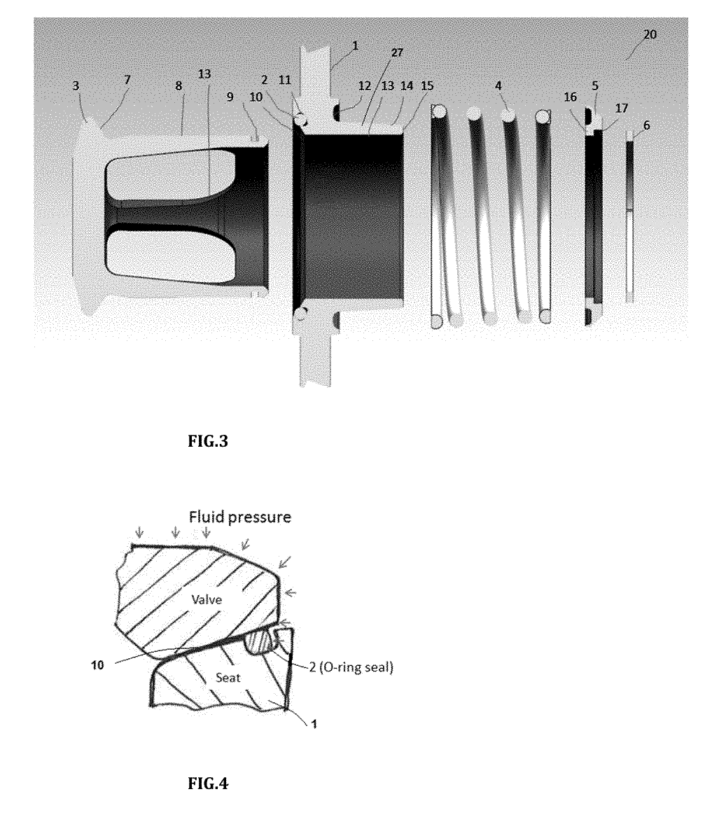

Referring now to FIG. 3, the closed end of valve cage 3 is disk-like and has a mating surface 7 to match seat surface 10 on the valve seat 1. The valve cage 3 has a cage body 8, which can be a long cylindrical barrel with one open end and plural windows along the side to allow for fluid flow therethrough. Near the open end of the valve cage 3, along an outer perimeter, there is a groove 9. The groove 9 may hold the lock ring 6.

Compression spring 4, preferably conically shaped for shorter coil binding length and no tangling, is axially placed outside of the guiding barrel body 27 in the valve seat 1 and retained in a recess pocket 16 in the retainer washer 5. The spring 4 is selected to provide sufficient bias force to rapidly pull the valve disk 7 resting on the valve seat 1 in a close phase, while allowing the valve disk 7 to proportionally lift (open) according to the pressure and flow in an open phase. When extreme situations occur, such that valve cage 3 lifts (opens) too much that severe compression would lead to spring coil 4 binding or tangling, the improved valve 20 prevents such a problem by a mechanical stop between an end 15 of the guiding barrel body 27 and face 16 on the spring retainer washer 5.

The retainer arrangement 27, including the spring retainer washer 5 and split lock ring 6, provides a quick and loose-proof locking mechanism. The split lock ring 6 has an inner diameter to fit into groove 9 at the valve cage body end, and an outer diameter to fit into the recess pocket 17 on the spring retainer washer 5. Under the bias expansion force from the compression spring 4, the spring retainer washer 5 always intends to move out from the valve open. However, due to the existence of split lock ring 6, it will not be able to do so. In the meantime, while the split lock ring 6 could open and escape from the groove 9, it will simply not be possible if a spring is present and pushing the retainer washer 5, as the recessed pocket 17 would not allow the lock ring 6 to expand to come out by itself. Such a simple and reliable mechanism will provide advantages on quick assembly and service requirements.

This combination of features results in advantages for valves used for reciprocating slurry pumps, including performance, durability, serviceability and cost.

The above represents example principles. Many embodiments can be made using these principles.

What is claimed is:

1. An improved check valve for use in a slurry fluid pump, the check valve comprising:
(a) a valve seat having a seating surface and a guiding barrel body; the seating surface having a groove;
(b) an elastomeric seal member oriented in the groove;
(c) a valve cage having a cylindrical valve cage body and opposite open and closed ends, the closed end being closed by a valve disk;
(i) the valve cage body having a plurality of windows allowing fluid flow therethrough;
(ii) the valve cage body being sized to slide inside of the guiding barrel body;
(iii) the valve cage further including a groove at an outer perimeter adjacent the open end of said valve cage body;
(d) a retainer arrangement including a washer and a lock ring;
(i) the washer having a recess pocket and being sized to slide over the valve cage and against the guiding barrel body;
(ii) the lock ring being seated within the groove of the valve cage and having an outer diameter sized to be oriented within the recess pocket of the washer; and
(d) a compression spring oriented outside of the guiding barrel body and held by the retainer arrangement between the open end of the valve cage and against the valve seat to urge the seating surface of the valve seat against the valve disk.

2. The check valve of claim 1 wherein the seal member is an o-ring.

3. The check valve of claim 2 wherein the o-ring is oriented at an outer perimeter of the seating surface.

4. The check valve of claim 1 wherein the seating surface is spherical.
